(19) United States
(12) Patent Application Publication
(10) Pub. No.: US 2025/0027843 A1
(43) Pub. Date: Jan. 23, 2025

(54) SOUND-TO-VIBRATION TRANSFORMATION FOR SENSORLESS MACHINE HEALTH MONITORING

(71) Applicant: QATAR UNIVERSITY, Doha (QA)

(72) Inventors: Serkan KIRANYAZ, Doha (QA); Ozer Can DEVECIOGLU, Tampere (FI); Amir ALHAMS, Doha (QA); Sadok SASSI, Doha (QA); Turker INCE, Izmir (TR); Onur AVCI, Morgantown, WV (US); Mohammad Hesam SOLEIMANI-BABAKAMALI, Los Angeles, CA (US); Ertugrul TACIROGLU, Los Angeles, CA (US); Moncef GABBOUJ, Tampere (FI)

(21) Appl. No.: 18/778,581

(22) Filed: Jul. 19, 2024

Related U.S. Application Data
(60) Provisional application No. 63/527,784, filed on Jul. 19, 2023.

(51) Int. Cl. G01M 13/045

(52) U.S. Cl. CPC G01M 13/045

(57) ABSTRACT

A sound-to-vibration transformation device and method to perform sensor-less fault detection of a rotating device may be provided. In some embodiments, the method for sound-to-vibration transformation may include acquiring at least one audio signal including audio of a rotating mechanical device and transforming the audio signal into a vibration data signal using a trained model. The vibration data may indicate vibration information of the rotating mechanical device.

### CROSS-REFERENCE TO RELATED APPLICATION

This application claims a priority benefit to U.S. Provisional Application No. 63/527,784, entitled “Sound-To-Vibration Transformation for Sensorless Machine Health Monitoring,” filed on Jul. 19, 2023, which is incorporated by reference in its entirety.

### TECHNICAL FIELD

This invention relates generally to sound-to-vibration transformation to perform sensor-less fault detection, and particularly in use for predictive maintenance of mechanical components, such as bearings in rotating machinery equipment.

### BACKGROUND

Motor fault detection may be one of the important aspects of a predictive maintenance pipeline in various industries, such as manufacturing, aerospace, and energy. Bearings may be one of the components of rotating machinery equipment which is commonly used in industry, and a failure of one or more bearings in the rotating machinery equipment can result in multiple delays and problems, such as unexpected downtime, increased maintenance costs, and even accidents.

### SUMMARY

Various exemplary embodiments may provide an apparatus including at least one processor configured to acquire at least one audio signal comprising audio of a rotating mechanical device and transform the audio signal into a vibration data signal using a trained model. The vibration data may indicate vibration information of the rotating mechanical device.

Certain exemplary embodiments may provide a method including acquiring, by a computational device, at least one audio signal comprising audio of a rotating mechanical device and transforming the audio signal into a vibration data signal using a trained model. The vibration data may indicate vibration information of the rotating mechanical device.

### BRIEF DESCRIPTION OF THE DRAWINGS

For proper understanding of the features of some exemplary embodiments, reference should be made to the accompanying drawings, as follows:

FIG. 1 illustrates an example of a different machine testing configurations, according to various exemplary embodiments;

FIG. 2 illustrates an example configuration for motor fault detection, according to some exemplary embodiments;

FIG. 3 illustrates an example of a network architecture for a model, according to certain exemplary embodiments;

FIG. 4 illustrates an example of a training scheme of a cascaded network model, according to some exemplary embodiments;

FIG. 5 illustrates an example of sound-to-vibration transformation results, according to various exemplary embodiments;

FIG. 6 illustrates an example of a flow diagram of a method, according to certain exemplary embodiments; and

FIG. 7 illustrates an example of a set of apparatuses, according to various exemplary embodiments.

### DETAILED DESCRIPTION

It will be readily understood that the components of certain exemplary embodiments, as generally described and illustrated in the figures herein, may be arranged and designed in a wide variety of different configurations. The following is a detailed description of some exemplary embodiments of systems, methods, and/or apparatuses for sound-to-vibration transformation configured for sensor-less machine health monitoring.

For effective predictive maintenance, it is desirable to perform failure detections. Bearings are one of the more common components of rotating machinery to fail. Conventionally, numerous methods and techniques have been presented to recognize and address bearing problems, which has led to increased focus on bearing fault identification. The conventional bearing fault identification techniques may include model-based methods, traditional signal-processing approaches, and machine learning (ML) and/or deep learning (DL) methods. The bearing fault identification techniques may each use vibration data to identify certain potential faults in the bearing or other components of the rotating machinery. Vibration data may be effectively used to determine and track changes in the mechanical behavior, such as the mechanical movement and function of the bearing.

As bearings begin to degrade, the vibration pattern or behavior may change. By examining changes and/or variations in the vibration pattern or behavior, it may be possible to identify bearing failure earlier and take corrective action before failure occurs. The conventional DL method may detect faults in rotating machines directly using raw vibration data. However, certain problems may occur in real-time implementations of these conventional DL fault detection methods. For example, reliable vibration data acquisition, especially from a rotating machine at high speeds, can be a challenging task. Electric motors can produce high levels of background noise including, for example, electrical interference, ambient vibrations, and sensor noise, which may cause noise and alter the vibration signals. Due to this noise, vibration readings may not be accurate, resulting in false alarms or missed detections.

In addition to these acquisition-induced problems, installing accelerometers with wires in certain locations of rotating machines may also pose certain difficulties and operational drawbacks. The vibration sensors, such as, for example, accelerometers, may not function with optimal performance and/or may fail or break under harsh operating and/or environmental conditions. Wireless accelerometers, especially with a high-resolution data capability, may be overly costly and may require burdensome periodic maintenance for a reliable acquisition. Another potential concern to be addressed may be the mounting location of vibration sensors, where slight positional variations may cause changes in vibration patterns. For each rotating machine, the vibration signals may be acquired by distinct accelerometers within a close proximity. Therefore, an ML and/or DL model trained using data from one of these vibration sensor for fault detection may underperform or may even fail on the data acquired from another sensor placement.

To address all the aforementioned concerns, certain exemplary embodiments may provide a sound-to-vibration transformation using sensor-less fault detection. Various exemplary embodiments may advantageously provide for the fault detection without using vibration sensors. In an example scenario according to some of the exemplary embodiments, once a fault detector is trained using vibration data acquired by an accelerometer at any location on a rotating device, such as a motor, a transformer according to certain exemplary embodiments may also be trained using the vibration data from the same sensor and using sound data provided by an external source, such as the manufacturer of the motor. The transformer may learn to synthesize realistic vibration data directly from the acquired sound measurements. For example, at least two trained models may be used: at least one model for the fault detector and at least one model for the transformer. The trained models may be shared with an operator, or device used by the operator, for health monitoring of the motor. This health monitoring may be performed on-demand, intermittently, or continuously.

Various exemplary embodiments may advantageously provide for generating realistic vibration signals which may be produced directly from the sound of the rotating device (e.g., the motor), which may be received from a recording device or any other device with audio recording capabilities, such as a mobile phone with microphone. The sound data may alternatively, or additionally, be received from a database or external source or device. Using the generated vibration signals, a detector which has been pre-trained using synthesized vibration data may be used for fault detection during the operational lifetime of the motor. Certain exemplary embodiments may therefore be able to allow machine operators to no longer need to purchase, install, and/or maintain vibration sensors, such as accelerometers, by using the same setup used by the manufacturer (e.g., the same sensor model installed at the same location during the training of the fault detector).

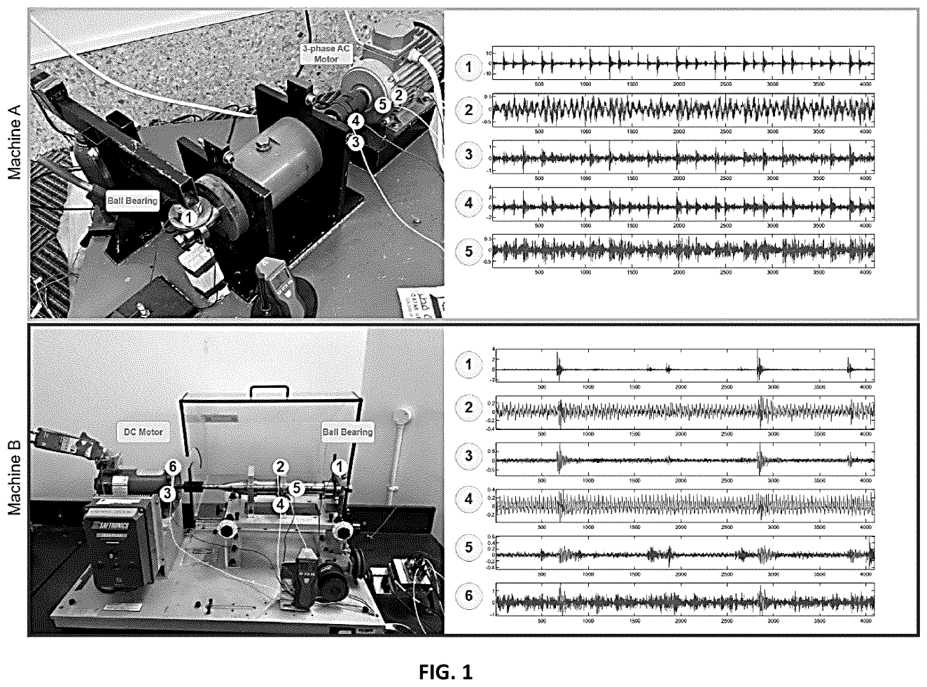

FIG. 1 illustrates an example of a different machine testing configurations, according to various exemplary embodiments. As an exemplary use-case scenario, besides the cost and energy savings, the approach of certain embodiments may also yield a robust fault detection. The fault detection may be provide by synthesizing a vibration signal that is similar to the one used during the training of a classifier by the manufacturer. The synthesized vibration signal may be obtained regardless of the noise or other variations. This may improve the reliability and accuracy of fault detection by a classifier that was pre-trained over the actual vibration signal.

Various exemplary embodiments may provide a 1D operational U-Net (Op-UNet) to be used as a network model for the transformer, such as a sound-to-vibration transformer. Alternatively, some exemplary embodiments may provide any other suitable network model which may be used for sound-to-vibration modeling. The Op-UNet may have a self-organized operational neural network (Self-ONN) architecture, which may be a heterogeneous network model with generative neurons that can perform optimal non-linear operations for each kernel element. Self-ONNs may be able to outperform convolutional neural networks (CNN) in certain tasks, even with a reduced network complexity and depth as compared to CNNs. Some exemplary embodiments may provide the ability to leverage this performance superiority to synthesize highly realistic vibration signals and achieve the same fault detection performance level by the manufacturer's pre-trained model over the original vibration signal.

Certain exemplary embodiments may provide various methods or techniques for synthetically generating the corresponding vibration signal directly from sound data and without using any accelerometer or other vibration sensor. For example, some exemplary embodiments may provide for an audio recorder (e.g., in a mobile phone) and ML modelling to provide for a continuous motor health monitoring and an accurate fault detection.

The quantitative experimental and/or testing results may show that the fault detection accuracy difference achieved using synthesized vibration data versus real vibration data may be less than 0.5%, which may be considered negligible in most scenarios. Regardless of the motor type (AC/DC), size, fault type/severity, and sound level, the quantitative experimental and/or testing results show that the various exemplary embodiments may transform a sound signal to synthesize the corresponding (predicted-real) vibration signal. Therefore, according to certain exemplary embodiments, it may be possible to make motor health monitoring significantly more practical and accessible, as it eliminates the need for a vibration sensor. Some exemplary embodiments may also be highly efficient, inexpensive, and robust by avoiding certain of the challenges and drawbacks associated with using accelerometers for data acquisition. Various exemplary embodiments may also be able to make predictive maintenance more accessible and practical for various other applications (e.g., mechanical fault detection on vehicles or any moving platform in general).

Certain exemplary embodiments may provide for using a novel sound-to-vibration transformation method that can synthesize realistic vibration signals directly from the sound measurements regardless of the working conditions, fault type, and fault severity. Using this sound-to-vibration transformation method, sound data acquired by a sound recorder, e.g., a microphone or other recording device, such as in a mobile phone, may be transformed into a vibration signal, which may then be used for fault detection by a pre-trained model. The apparatus and method of various exemplary embodiments may be evaluated relative to the benchmark Qatar University Dual-Machine Bearing Fault Benchmark dataset (QU-DMBF), which encapsulates sound and vibration data from two different machines operating under various conditions, such as Machine A and Machine B shown in FIG. 1. Experimental results may provide that synthesizing realistic vibration signals may directly be used for reliable and highly accurate motor health monitoring. FIG. 1 shows raw vibration signals from the two distinct machines used in the QU-DMBF dataset. For each machine (Machine A and Machine B), vibration signals may be acquired by distinct vibration sensors, such as accelerometers, within a relatively close proximity which provides an accurate detection. As shown in FIG. 1, the signals from different accelerometers may be entirely different from one another. For example, even though sensors 2 and 5 from Machine A and sensors 6 and 3 as well as 2, 5, and 4 from Machine B are placed close to each other, the obtained vibration signals may be different. Therefore, a DL model trained over one of these sensors for fault detection may underperform or may even fail on the data acquired from another sensor placement.

Various exemplary embodiments may provide for addressing the potential for these sensors underperforming or even failing on the data acquired from another sensor placement. A fault detector may be trained over vibration data acquired by an accelerometer at any location, and the sound-to-vibration transformer may be trained using the vibration data from the same sensor and sound data, either acquired from a device or the manufacturer of the motor, or any other suitable source. The sound-to-vibration transformer may then learn to synthesize realistic vibration data directly from the acquired sound measurements. The two trained models for the fault detector and the sound-to-vibration transformer may then be used for health monitoring.

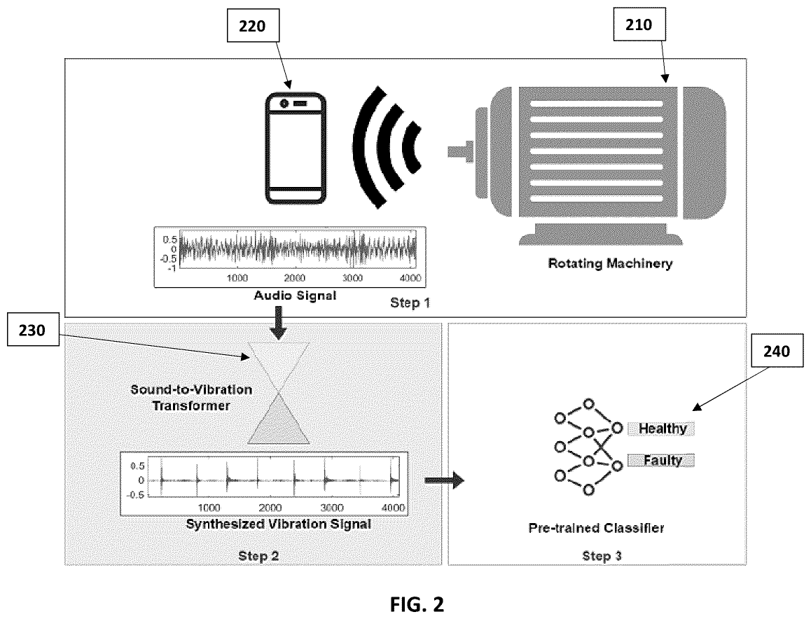

FIG. 2 illustrates an example configuration for motor fault detection, according to certain exemplary embodiments. The example configuration shown in FIG. 2 may include a rotating machine (e.g., a motor) 210, an audio recording device (e.g., microphone in a device) 220, a sound-to-vibration transformer 230, and, optionally, a pre-trained classifier 240. The audio recording device 220 may detect and record audio signals received from the rotating machine 210 and provide the audio signals to the sound-to-vibration transformer 230. The sound-to-vibration transformer 230 uses the audio signals as inputs to an ML or DL trained model stored therein for use by the sound-to-vibration transformer 230.

The trained ML or DL model may output a synthesized vibration signal which is a predicted or calculated vibration signal which represents a real-world vibration signal, without the need to actually measure the rotating machine 210 using a vibration sensor. The synthesized vibration signal may be input to the pre-trained classifier 240 to determine whether the synthesized vibration signal indicates a healthy or faulty vibration of the rotating machine 210, such as caused by a faulty bearing.

Certain exemplary embodiments may provide that the sound-to-vibration transformer implements an Op-UNet, with may have a Self-ONN architecture. Self-ONNs may be different from the convolution operator of CNNs and a nodal operator of each generative neuron of a Self-ONN may perform any non-linear transformation, which may be expressed based on Taylor approximation near origin using Equation (1):

$$ψ ( x ) = {\sum }_{n = 0}^{∞} \frac{{ψ}^{( n )} ( 0 )}{n !} {x}^{n} \qquad ( 1 )$$

Where the ψ(x) is the Taylor series function, ω⁽ⁿ⁾(0) is the nth derivative of ψ evaluated at a point=0, and x is the evaluation point.

A Q^{th} order truncated approximation of Equation (1), formally known as the Taylor polynomial, may be represented by a finite summation as shown by Equation (2):

$${ψ ( x )}^{( Q )} = {\sum }_{n = 0}^{Q} \frac{{ψ}^{( n )} ( 0 )}{n !} {x}^{n} \qquad ( 2 )$$

Equation (1) may approximate any arbitrary function ψ(x) near 0. When the activation function bounds the neuron's input feature maps in the vicinity of 0 (e.g., tanh), the Equation (2) may be used to form a composite nodal operator where the power coefficients,

$$\frac{\text{?}}{\text{?}} ,$$

$$\text{?} \text{indicates text missing or illegible when filed}$$

can be the parameters of the network learned during training.

A 1D nodal operator of a k^{th} generative neuron in an l^{th} layer with the i^{th} neuron located at the (l−1)^{th} layer being an input map of the l^{th} layer may be expressed by Equation (3):

$$( m ) = {\sum }_{r = 0}^{K - 1} {\sum }_{q = 1}^{Q} {w}_{ik}^{l ( Q )} ( r , q ) {( {y}_{i}^{l - 1} ( m + r ) )}^{q} \qquad ( 3 )$$

where yᵢ^{l-1}∈ [symbol] is the output map of the i^{th} neuron at the (l−1)^{th} layer, wᵢₖ^{l(Q)} is a learnable kernel of the network, which is a K×Q matrix, formed as wᵢₖ^{l(Q)}(r)=[wᵢₖ^{l(Q)}(r,1), wᵢₖ^{l(Q)}(r,2), wᵢₖ^{l(Q)}]. By the commutativity of summation operations in Equation (3), this expression may alternatively be represented by Equation (4) and simplified to Equation (5):

$$( m ) = {\sum }_{q = 1}^{Q} {\sum }_{r = 0}^{K - 1} {w}_{ik}^{l ( Q )} ( r , q - 1 ) {{y}_{i}^{l - 1} ( m + r )}^{q} \qquad ( 4 )$$

$$= {\sum }_{q = 1}^{Q} Conv 1 D ( {w}_{ik}^{l ( Q )} , {( {y}_{i}^{l - 1} )}^{q} ) \qquad ( 5 )$$

The formulation may be accomplished by applying Q 1D convolution operations and the output of this neuron may be represented as Equation (6):

$${x}_{k}^{l} = {b}_{k}^{l} + \text{?} {x}_{ik}^{l} \qquad ( 6 )$$

$$\text{?} \text{indicates text missing or illegible when filed}$$

where bₗ^{k} is the bias associated with this neuron. The 0^{th} order term, q=0, the DC bias, may be ignored as its additive effect can be compensated by a learnable bias parameter of the neuron. With the Q=1 setting, a generative neuron reduces to a convolutional neuron.

Various exemplary embodiments may provide implementing this Op-UNet with Self-ONN architecture to synthesize realistic vibration signals of a motor from the sound of the motor so that the synthesized vibration data may directly be used for accurate fault detection by an original classifier pre-trained on the actual vibration data. For example, 1-second paired audio and vibration signals may be used to train the Op-UNet. Each segment may be linearly normalized using Equation (7):

$${X}_{N} ( i ) = \frac{2 ( X ( i ) - {X}_{min} )}{{X}_{max} - {X}_{min}} - 1 \qquad ( 7 )$$

where X(i) is the original sample amplitude in the segment, X_{N}(i) is the normalized segment, Xₘᵢₙ and Xₘₐₓ are the minimum and maximum amplitudes within the segment, respectively. This may scale the segment linearly in the range of [−1 1], where Xₘᵢₙ→−1 and Xₘₐₓ→1.

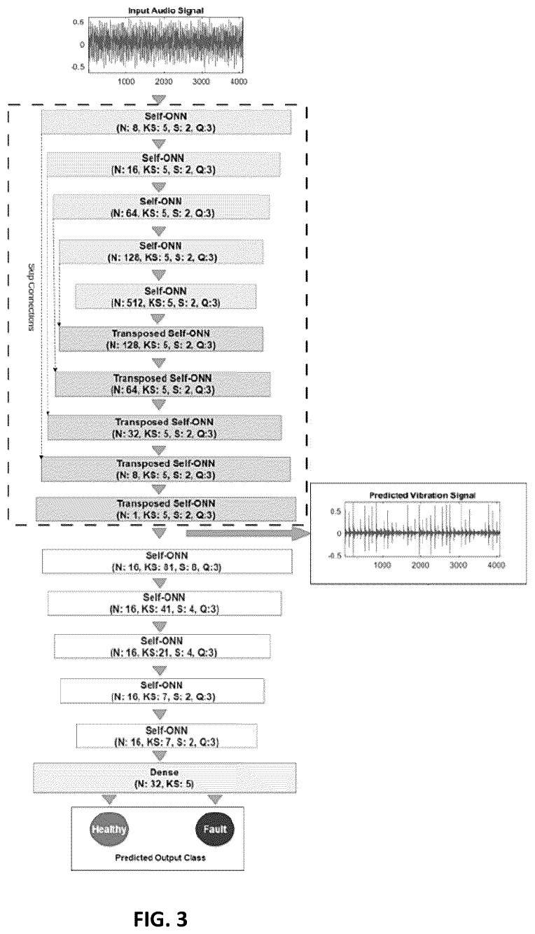

FIG. 3 illustrates an example of a network architecture for the Op-UNet model, according to certain exemplary embodiments. The network architecture for the Op-UNet model may have several operational layers, such as a total of 15 operational layers, as shown in FIG. 3. The first 10 layers may be organized into an Op-UNet model which may include 5 operational layers in an encoder and 5 transposed operational layers in a decoder with skip connections. This may represent a transformer network, where the input and output of the network may be the 1-second sound data/signal and the corresponding vibration segments, respectively.

To reinforce the learning/training process of the Op-UNet, by emphasizing the fault status of a given signal, in addition to the 10-layer U-Net, the sound-to-vibration transformer network may be cascaded with a Self-ONN classifier which includes 5 operational layers and 2 dense layers. By cascading the Self-ONN classifier to the sound-to-vibration transformer, the ML/DL training may use be able to discriminate fault segments from normal segments, which may improve the regression transformation. After training is complete, the Self-ONN classifier may be ignored.

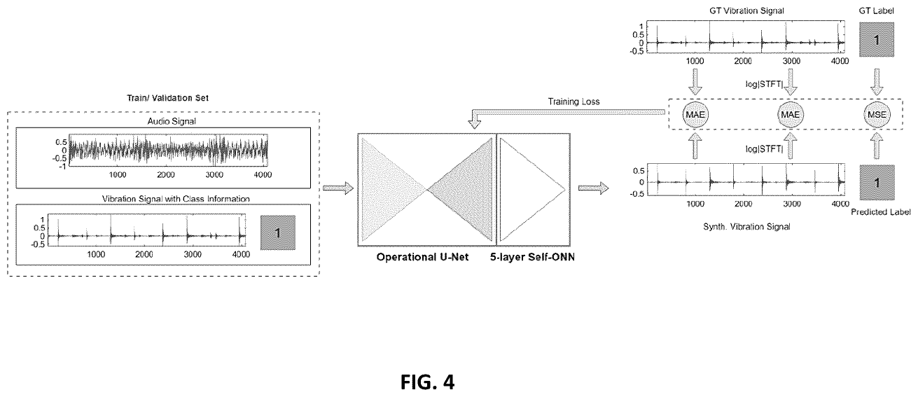

FIG. 4 illustrates an example of a training scheme of a cascaded network model of Op-UNet, according to some exemplary embodiments. An objective function used for training may include a combination of, for example, three distinct loss functions. To generate more realistic vibration signals, both temporal and spectral signal representations may be taken into consideration by utilizing their corresponding loss functions, respectively. Certain exemplary embodiments may be able to minimize a mean-absolute error (MAE) in both time and frequency domains. An MAE loss function in the time domain may be presented by Equation (8):

$${Loss}_{Time} = {‖ ( Y - Synth ( {X}_{N} ) ) ‖}_{1} \qquad ( 8 )$$

Where X_{N} is the normalized input sound signal, Synth(X_{N}) is the synthesized vibration signal and Y is the corresponding actual vibration signal.

For a spectral loss function, an N-point discrete short-time Fourier transform (STFT) of the input and output signals may be performed using Equation (9):

$$STFT [ X , w , n ] = X ( n , w ) = {\sum }_{m} X [ m ] W [ n - m ] \text{?} \qquad ( 9 )$$

$$\text{?} \text{indicates text missing or illegible when filed}$$

Where X is the input signal and W is a window function.

Equation (10) may formulate a complex-valued N-point discrete STFT from which the N-point discrete spectrogram, Spec(X(n,k)), may be computed, with a value of an N=256 samples Hanning window with 128 samples which overlap. Equations (11) and (12) may then formulate the spectral and classification loss functions, respectively.

$$X ( n , k ) = X ( n , w ) {\vert}_{w = \frac{2 π k}{N}} \to Spec ( X ( n , k ) ) = {\vert X ( n , k ) \vert}^{2} \qquad ( 10 )$$

$${Loss}_{STFT} = {‖ STFT ( Y ) = Synth ( X ) ‖}_{1} \qquad ( 11 )$$

$${Loss}_{class} = \frac{1}{N} {\sum }_{i = 0}^{N} {( C ( Y ) - C ( Synth ( X ) ) )}^{2} \qquad ( 12 )$$

Where, C(Y)and C(Synth(X)) are class labels of the actual vibration signal and the synthesized vibration signal, respectively.

The overall objective function used for training may then combine all loss functions and may be expressed as Equation (13):

$${Loss}_{total} = {Loss}_{class} + λ ( {Loss}_{Time} + {Loss}_{STFT} ) \qquad ( 13 )$$

Where λ is the weight parameter that balances the temporal and spectral loss with classification loss.

An evaluation of the sensor-less motor fault detection method and configuration according to various exemplary embodiments may aid in demonstrating the advantageous processes and effects of the various exemplary embodiments.

A benchmark dataset may be used in evaluating and training the ML/DL models, such as the dataset established by Qatar University using the different electric machines shown in FIG. 1 (Machine A and Machine B). The experimental setup shown in FIG. 1 illustrates an example of the orientation of the sensors and the installation of two machines.

The configuration for Machine A may include a 3-phase AC motor, two double-row bearings, and a shaft rotating at a maximum speed of, for example, 2840 RPM. A spring mechanism may be located a 6 kips radial load on the shaft and bearing. Printed circuit board (PCB) accelerometers (e.g., 352C33 high sensitivity Quartz ICP) may be mounted on the bearing housing. In this example, Machine A may, for example, weigh 180 kg and may be 100×100×40 cm. The working conditions for Machine-A may be based on the following: (i) 19 different bearing configurations—1 healthy and 18 fault cases with 9 having a defect on the outer ring, and 9 having a defect on the inner ring, and the defect sizes vary from 0.35 mm to 2.35 mm; (ii) 5 different accelerometer localizations in 3 different radial positions and 2 different axial directions; (iii) 2 different load (force) levels at 0.12 kN and 0.20 kN; and (iv) 3 different speeds of 480 RPM, 680 RPM, and 1010 RPM.

In evaluating Machine A, data may be obtained for a period of time, such as 270 seconds, for each operating circumstance for a healthy bearing, and a period of time, such as 30 seconds, for each faulty bearing case. This results in a total time of 30×18×5×2×3=16,200 seconds of data measurement. The sound was also simultaneously recorded with the same sampling frequency as the vibration data.

The configuration for Machine B may include a DC motor, two single-row bearings, and a shaft with a constant rotating speed of, for example, 2000 RPM. A spring mechanism may be installed at, for example, 6 kips radial load on the shaft and bearing. PCB accelerometers (e.g., 353B33 high sensitivity Quartz ICP) may be mounted on the bearing housing. In this example, Machine B may weigh 3.5 kg and the configuration may measure 165×82×63 cm. The working conditions for Machine B may be based on the following: (i) 19 different bearing configurations, including 1 healthy, 9 with a defect on the outer ring, and 9 with a defect on the inner ring, in which the defect sizes vary from 0.35 mm to 2.35 mm; (ii) 6 different accelerometer positions; (iii) a fixed load (force) of 0.40 kN, and 5 different speeds of 240 RPM, 360 RPM, 480 RPM, 700 RPM, and 1020 RPM.

In this example, for evaluating Machine B, 270 seconds of vibration sound data may be obtained for each operating condition for a healthy bearing. As a result, the total time of the healthy bearing vibration data may be, for example, 270×6×1×5=8,100 seconds. 30 seconds of vibration sound data may be obtained for each working condition for each faulty bearing, which may result in a 2:1 ratio of the faulty to healthy data, with a total time of, for example, 30×18×6×1×5=16,200 seconds. As a result, the dataset for Machine B includes 24,300 seconds in total (6.75 hours). The sound of each machine may be simultaneously recorded with the same sampling frequency as the vibration data.

Various exemplary embodiments may advantageously provide for sound signal acquisition unrelated to the location on the motor because a location sensitivity does not exist. For example, even a DL classifier trained on data acquired by one sensor may fail to detect certain faults in data from another sensor at a different location. The more reliable vibration data for fault detection may be acquired from the closest vibration sensor, e.g., accelerometer, to the bearing, i.e., accelerometer-1 for both Machine A and Machine B. For this exemplary evaluation, the accelerometers closest to the bearings may be selected for training the sounds-to-vibration transformers of both machines, which may be used to synthesize the corresponding vibration signal which is evaluated against an actual vibration signal.

Certain exemplary embodiments may provide for training of the sensor-less motor fault detection ML/DL network model, which includes use of the Op-UNet, the Self-ONN classifier, a batch size of 8, and a maximum of, for example, 1000 back-propagation (BP) iterations. For example, an ADAM optimizer with an initial learning rate of 10-4 may be used via BP. The parameter λ may be set to 100 (see Equation (13)). The training may use the first 2100 seconds of sound signals and the vibration counterparts, and the next 800 seconds of data may be used for the validation set. For both machines (Machine A and Machine B), a data partition with one of the speed settings may be spared for testing.

In this example, the fault detector may be, for example, a compact 1D Self-ONN model with 5 operational layers and 2 dense layers, in which 32 neurons may be in the hidden dense layer and 16 neurons may be in each of the hidden operational layers. For the binary classification task, the output layer may have two neurons and the input layer neuron may record a 1-second vibration segment. In all layers, the “tanh” nonlinear activation function may be employed. Kernel sizes of the operational layers may be set at 81, 41, 21, 7, and 7, respectively, and may have corresponding strides of 8, 4, 2, 2, and 2. The ADAM optimizer may be used with the initial learning factor (a) set to 10-4 for the BP training. Further, the loss function may be the Mean-Squared-Error (MSE) and the maximum number of BP iterations (epochs) may be set to 50. For example, both transformer and fault detector networks may use a FastONN library based on PyTorch.

To demonstrate the performance of the sensor-less motor fault detection ML/DL network model and method according to various exemplary embodiments, quantitative and qualitative evaluations have been performed. Table 1 illustrates performance results of exemplary tests/evaluations performed using the procedure, according to various exemplary embodiments.

TABLE 1

| | | | Healthy | | | Faulty | | |
|---|---|---|---|---|---|---|---|---|
| | | Accu- | Sensi- | Preci- | F1- | Sensi- | Preci- | F1- |
| Train | Test | racy | tivity | sion | Score | tivity | sion | Score |
| Data | Data | (%) | (%) | (%) | (%) | (%) | (%) | (%) |
| RA | RA | 99.70 | 100 | 99.12 | 99.56 | 99.54 | 100 | 99.77 |
| RA | SA | 99.76 | 100 | 99.12 | 99.56 | 99.51 | 100 | 99.76 |
| RB | RB | 97.56 | 93.67 | 99.55 | 96.52 | 99.76 | 96.54 | 98.12 |
| RB | SB | 97.17 | 98.51 | 93.43 | 95.90 | 96.48 | 99.22 | 97.83 |

In Table 1, four different training and testing scenarios were selected to validate the effectiveness of the sensor-less motor fault detection ML/DL network model and method according to various exemplary embodiments. In each scenario, the classifier was trained and tested with non-overlapping real and synthesized vibration signals for two independent machines. To provide a clear representation of these scenarios, abbreviations were used in the table for the synthesized and real data for Machine A and Machine B as SA, RA, SB, and RB, respectively, where RA and RB correspond to real vibration signals. The 2nd and 4th row of Table 1 shows the classification performance of the sensor-less motor fault detection ML/DL network model and method over the synthesized vibration signals, SA and SB, respectively.

Certain exemplary embodiments may provide that the models trained over the real vibration data, and tested over both real and synthesized data, have a high-detection performance. The results between Machine A and Machine B over real and synthesized data may differ by up to only 0.4%, which may be considered negligible. Some exemplary embodiments may transform sound into vibration signals with optimal performance such that the transformed vibration signals may be similar to the real counterparts and thus, the pre-trained detector can achieve a fault detection performance substantially similar to the real vibration data.

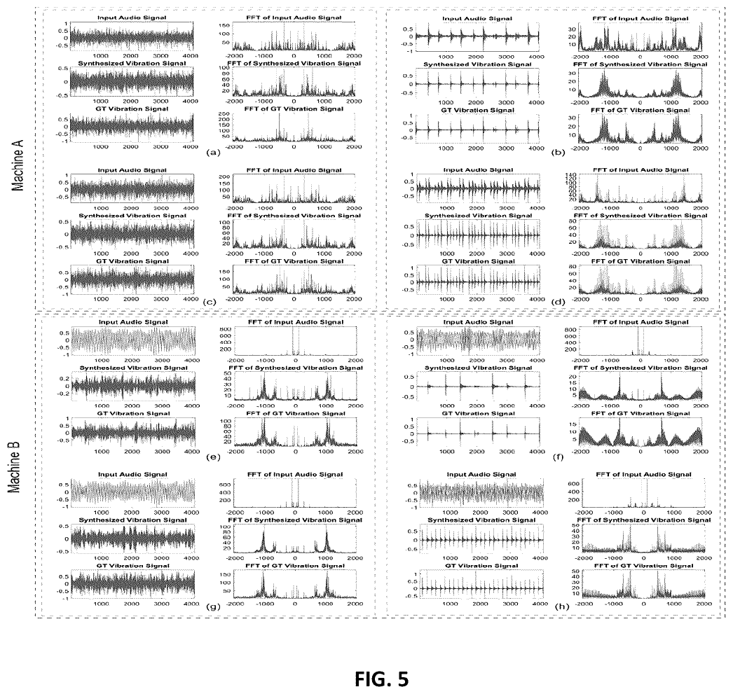

FIG. 5 illustrates an example of sound-to-vibration transformation results, according to various exemplary embodiments. FIG. 5 shows the results of 8 sets of sound, real and synthesized signals in both time and frequency domains corresponding to both healthy and faulty data from both machines. The results provide that the synthesized vibration signals may be similar to the real counterparts, regardless of the data class (healthy or faulty). The spectral representation may provide that the transformation may synthesize vibration signals that share the same spectral signatures of their real counterparts, i.e., the spectral peak locations representing the major spectral components in both healthy and faulty vibration data match. The sound-to-vibration transformation method according to some exemplary embodiments may suppress high-frequency peaks and may amplify the low-frequency peaks in accordance with the actual spectrum.

The fault detection accuracy difference achieved using synthesized and real data may be less than 0.5%, which is negligible. Regardless of the motor type (AC/DC), size, fault type/severity, and sound level, the results demonstrate that the motor fault detection method according to some exemplary embodiments may transform the sound signal to synthesize the corresponding (real) vibration signal, which improves motor health monitoring by making it more practical and accessible.

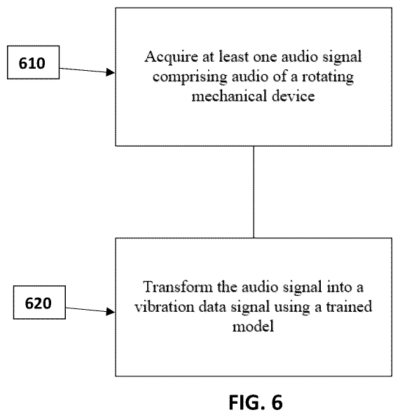

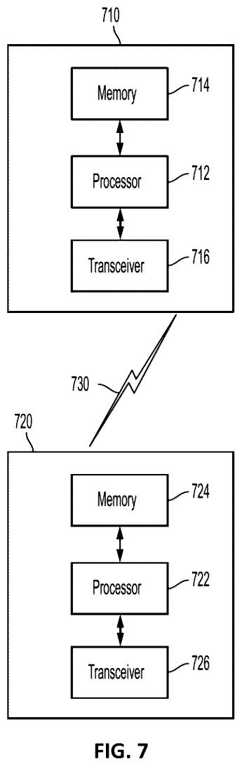

FIG. 6 illustrates an example of a flow diagram of a method, according to certain exemplary embodiments. In an exemplary embodiment, the method of FIG. 6 may be performed by a sound-to-vibration transformer, similar to apparatus 710 illustrated in FIG. 7.

According to various exemplary embodiments, the method of FIG. 6 may include, at 610, acquiring, by a computational device, such as the sound-to-vibration transformer, at least one audio signal comprising audio of a rotating mechanical device. The method may also include, at 620, transforming the audio signal into a vibration data signal using a trained model. The vibration data may indicate vibration information of the rotating mechanical device.

Certain exemplary embodiments may provide that the audio signal is used as an input to the trained model and the vibration data signal is an output of the trained model. The trained model may be trained using a vibration data obtained by a sensor located on the rotating mechanical device and sound data provided by an external source. The method may further include outputting the transformed vibration signal to a classifier which classifies whether the vibration information indicates a healthy vibration or a faulty vibration of the rotating mechanical device. The computational device may operate as the classifier.

Some exemplary embodiments may provide that the trained model is a self-organized operational neural network. The trained model may be comprised of a plurality of operational layers and may be cascaded with a self-organized operational neural network classifier comprising a plurality of additional operational layers and one or more dense layers. The trained model may implement a discrete short-time Fourier transform to transform the audio signal into the vibration data signal. The at least one audio signal may be acquired from an audio recorder located in a proximity of the rotating mechanical device.

As shown in FIG. 7, various exemplary embodiments may provide an apparatus 710 and an apparatus 720 which may be a computational device, such as a computer or other computational device, mechanical diagnostic device, or computer system. The apparatuses 710 and 720 may include at least one processor 712 and at least one processor 722, respectively, which may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While two processors may be discussed and shown in FIG. 7, only one processor or more than two processors may be utilized according to other exemplary embodiments. For example, it should be understood that, in certain exemplary embodiments, apparatuses 712 and 722 may include two or more processors that may form a multiprocessor system that may support multiprocessing.

The apparatus 710 and the apparatus 720 may each include at least one memory storing instructions that, when executed by the processors 712 and 722, respectively cause the apparatuses 710 and 722 to perform one or more methods, procedures, and/or processes according to various exemplary embodiments discussed herein. The memory 714 may be internal or external to the apparatus 712 and may be coupled to the processor 712 for storing information and instructions. The memory 724 may be internal or external to the apparatus 720 and may be coupled to the processor 722 for storing information and instructions.

Memory 714 and memory 724 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 714 and memory 724 can be comprised of any combination of random access memory (RAM), read only memory (ROM), static storage such as a magnetic or optical disk, hard disk drive (HDD), or any other type of non-transitory machine or computer readable media.

According to certain exemplary embodiments, processors 712 and 722, and memory 714 and 724 may be included in or may form a part of processing circuitry or control circuitry. In addition, in some example embodiments, transceivers 716 and 726 may be included in or may form a part of transceiving circuitry.

According to certain exemplary embodiments, the apparatus 710 may be caused, by the processor 712, which may optionally execute instructions stored in the memory 714, to at least acquire at least one audio signal comprising audio of a rotating mechanical device and transform the audio signal into a vibration data signal using a trained model. The vibration data may indicate vibration information of the rotating mechanical device.

Various exemplary embodiments may also provide a method performed by an apparatus, such as apparatus 710. The method may include acquiring, by a computational device, at least one audio signal comprising audio of a rotating mechanical device and transforming the audio signal into a vibration data signal using a trained model. The vibration data may indicate vibration information of the rotating mechanical device.

As used herein, the term “circuitry” may refer to hardware-only circuitry implementations (for example, analog and/or digital circuitry), combinations of hardware circuits and software, combinations of analog and/or digital hardware circuits with software/firmware, any portions of hardware processor(s) with software, including digital signal processors, that work together to cause an apparatus (for example, apparatus 710 and/or 720) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor or multiple processors, or portion of a hardware circuit or processor, and the accompanying software and/or firmware. The term circuitry may also cover, for example, a baseband integrated circuit in a server, cellular network node or device, or other computing or network device.

A computer program product may include one or more computer-executable components which, when the program is run, are configured to carry out some example embodiments. The one or more computer-executable components may be at least one software code or portions of it. Modifications and configurations required for implementing functionality of certain example embodiments may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (for example, apparatuses 710 and/or 720), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to certain example embodiments, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

The features, structures, or characteristics of exemplary embodiments described throughout this specification may be combined in any suitable manner in one or more exemplary embodiments. For example, the usage of the phrases “certain embodiments,” “an exemplary embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an exemplary embodiment,” “in some embodiments,” “in other embodiments,” or other similar language, throughout this specification do not necessarily refer to the same group of embodiments, and the described features, structures, or characteristics may be combined in any suitable manner in one or more exemplary embodiments.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

One having ordinary skill in the art will readily understand that the disclosure as discussed above may be practiced with procedures in a different order, and/or with hardware elements in configurations which are different than those which are disclosed. Therefore, although the disclosure has been described based upon these exemplary embodiments, it would be apparent to those of skill in the art that certain modifications, variations, and alternative constructions would be apparent, while remaining within the spirit and scope of the exemplary embodiments or the invention as disclosed.

We claim:

1. An apparatus, comprising:
at least one processor configured to:
acquire at least one audio signal comprising audio of a rotating mechanical device; and
transform the audio signal into a vibration data signal using a trained model, wherein the vibration data indicates vibration information of the rotating mechanical device.

2. The apparatus according to claim 1, wherein the audio signal is used as an input to the trained model and the vibration data signal is an output of the trained model.

3. The apparatus according to claim 1, wherein the trained model is trained using a vibration data obtained by a sensor located on the rotating mechanical device and sound data provided by an external source.

4. The apparatus according to claim 1, wherein the at least one processor is further configured to:
output the transformed vibration signal to a classifier which classifies whether the vibration information indicates a healthy vibration or a faulty vibration of the rotating mechanical device.

5. The apparatus according to claim 4, further comprising the classifier, wherein the at least one processor operates as the classifier.

6. The apparatus according to claim 1, wherein the trained model is a self-organized operational neural network.

7. The apparatus according to claim 1, wherein the trained model is comprised of a plurality of operational layers and is cascaded with a self-organized operational neural network classifier comprising a plurality of additional operational layers and one or more dense layers.

8. The apparatus according to claim 1, wherein the trained model implements a discrete short-time Fourier transform to transform the audio signal into the vibration data signal.

9. The apparatus according to claim 1, wherein the at least one audio signal is acquired from an audio recorder located in a proximity of the rotating mechanical device.

10. A method, comprising:
acquiring, by a computational device, at least one audio signal comprising audio of a rotating mechanical device; and
transforming the audio signal into a vibration data signal using a trained model, wherein the vibration data indicates vibration information of the rotating mechanical device.

11. The method according to claim 10, wherein the audio signal is used as an input to the trained model and the vibration data signal is an output of the trained model.

12. The method according to claim 10, wherein the trained model is trained using a vibration data obtained by a sensor located on the rotating mechanical device and sound data provided by an external source.

13. The method according to claim 10, further comprising:
outputting the transformed vibration signal to a classifier which classifies whether the vibration information indicates a healthy vibration or a faulty vibration of the rotating mechanical device.

14. The method according to claim 13, wherein the computational device operates as the classifier.

15. The method according to claim 10, wherein the trained model is a self-organized operational neural network.

16. The method according to claim 10, wherein the trained model is comprised of a plurality of operational layers and is cascaded with a self-organized operational neural network classifier comprising a plurality of additional operational layers and one or more dense layers.

17. The method according to claim 10, wherein the trained model implements a discrete short-time Fourier transform to transform the audio signal into the vibration data signal.

18. The method according to claim 10, wherein the at least one audio signal is acquired from an audio recorder located in a proximity of the rotating mechanical device.
